(19) United States
(12) Patent Application Publication
(10) Pub. No.: US 2017/0339849 A1
(43) Pub. Date: Nov. 30, 2017

(54) SHIELD FOR PROTECTING PLANTS

(71) Applicant: Fruit Shield Inc., Los Angeles, CA (US)

(72) Inventor: Samir Fawzi Masri, Anaheim Hills, CA (US)

(21) Appl. No.: 15/165,480

(22) Filed: May 26, 2016

(51) Int. Cl. A01G 13/04; A01G 1/00

(52) U.S. Cl. CPC A01G 13/043; A01G 1/001

(57) ABSTRACT

A shield for protecting a plant having; a stem having an upper end and a lower end; a first plurality of sticks having a proximal end and a distal end; and a pad associated with the upper end of the stem, the pad having a second plurality of holes distributed all around the pad and oriented at various angles in relation to a horizontal plane, the holes being configured for removably receiving the proximal ends of the entire first plurality of sticks or a portion thereof and securing the same therein through friction-based insertion; the second plurality of holes distribution and orientation allowing the formation of a support structure for a protective cover in which the entire first plurality of sticks or a portion thereof extends in a circular arrangement above the plant at an angle conforming to the shape or size of the plant.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

### 1. Field of the Invention

The invention relates generally to agriculture and more specifically to the protection of crops, trees, and other plants from pests and weather.

### 2. Description of the Related Art

Growers of fruit trees, vegetables, and other crops or plants often suffer from the loss of some of their crops due to inclement weather and/or pests. Pesticides and other such chemicals used to combat this loss may also end up harming the plants. Greenhouses may be used to give the crops some protection, but these greenhouses requires a high amount of labor to install and build, and the greenhouses may not be suitable for smaller batches of crops, and are not practical for users who only wish to protect a small amount of plants. The greenhouses may also not be suitable for temporary use, due to the high amount of labor needed for the installation and the takedown. The greenhouses may also be expensive or cost-prohibitive for the user.

Thus, there is a need for a product that reduces the use of chemicals for growing crops, while still providing protection for the crops from bugs, birds, and other pests, in a cost-effective way.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect a shield is provided having a frame, combined with a cover supported by the frame and used to cover fruit trees, crops, and other plants without touching the plants. The shield protects the plants from pests and heavy weather such as frost, wind, or hail. An advantage is that costs and labor are reduced by eliminating the use of greenhouses. Another advantage is that the use of pesticides is reduced by physically blocking pests from the plants, which may reduce contamination of water by pesticides, and the increase the availability of organic crops. Another advantage is that less bees will be killed by the reduction in pesticide use, and pollination control is also provided for the users, giving them the ability to keep bees and other pollinators in or out of the cover as needed.

In another aspect, a shield is provided having a bunker frame, combined with legs and a cover and used to cover vegetables, fruits, smaller trees, and other plants without being supported by or resting on the plants, protecting the plants from pests and heavy weather such as frost, wind, or hail. An advantage is that costs and labor are reduced by eliminating the use of greenhouses. Another advantage is that the use of pesticides is reduced by physically blocking pests from the plants.

In another aspect, a breathable and durable cover is provided that is combinable with a frame, and expandable in size by the user by attaching a plurality of pieces together. An advantage is that anything may be protected according to the needs of the user, by adding several covers together and customizing the size of the cover.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 shows a top perspective view of a shield having a frame and a cover, for protection of trees, according to an aspect.

FIG. 2a illustrates a side view of the frame that may support the cover of a shield, according to an aspect.

FIG. 2b illustrates side views of pads that may be placed at an upper end of the frame stem, according to an aspect.

FIG. 3 shows a side view of a frame that may be installed on a fruit tree, according to an aspect.

FIG. 4 shows a side view of a shield, having cover supported by a frame, protecting a tree, according to an aspect.

FIG. 5 shows a top perspective view of a shield having a bunker frame and a cover, placed over crops for protection of the crops, according to an aspect.

FIG. 6 shows a side perspective view of the bunker frame that may be positioned over the crops to be protected by the shield, according to an aspect.

FIGS. 7a-7b show examples of side perspective views of a bunker frame having two legs, according to an aspect.

FIG. 8 shows a top perspective view of a post that may support the bunker frame of FIG. 5, showing that the post may be hollow, according to an aspect.

FIG. 9 shows a side view of a post with a bunker stick inserted into the hollow shaft of the post.

FIG. 10 shows a front view of the post, showing that the lower end of the post may be pointed for facilitating driving the post into the soil, according to an aspect.

FIG. 11 shows a top side perspective view of the post, placed upright into the soil, according to an aspect.

FIG. 12 shows a side perspective view of a bunker shield with a cover having a looped edge, according to an aspect.

FIG. 13 shows a side perspective view of a screen house bunker shield, according to an aspect.

FIG. 14 shows a front top perspective view of a screen house bunker shield, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

For the following description, it can be assumed that most correspondingly labeled elements across the figures (e.g., 206 and 306, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

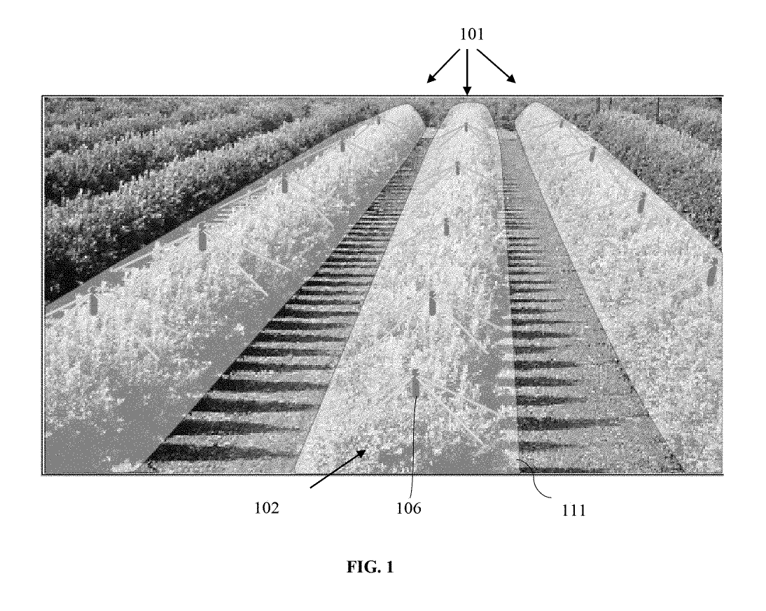

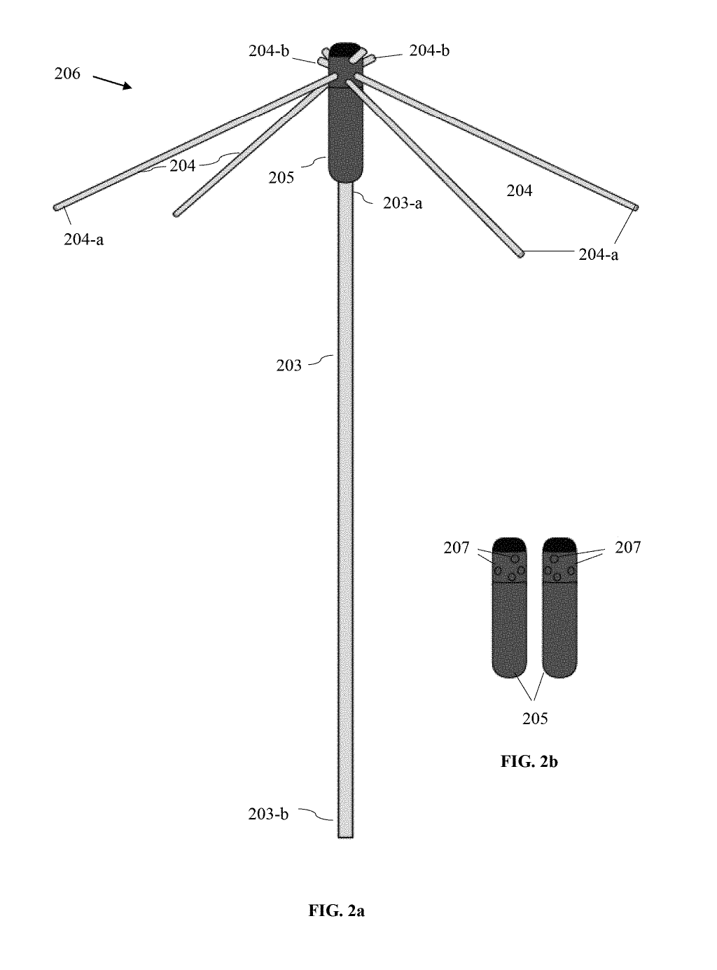

FIG. 1 shows a top perspective view of a shield 101 (“shield,” “fruit shield,” or “crop shield”) having a frame 106 and a cover 111 (“cover,” “net” or “netting”), for protection of trees 102, according to an aspect. The frame (as shown in FIG. 2) may be a support structure having a stem (as shown as 203 in FIG. 2), and may be used to spread the cover over crops or any other type of plant, such that the cover is not supported by the plant itself. The cover may be constructed from cloth, may be woven, and may be a mesh material, such as a net. The mesh may be fine enough to prevent insects, bugs, and other pests from reaching the crops, while still providing protection. The cover may also help to retain moisture inside of the shielded area for benefit of the crops being protected. The cover may also be a non-woven material such as, for example, plastic. As an example, the cover may be constructed of polyethylene. An advantage of the polyethylene is its durability, and the cover may last for more than 4 years under outdoor weather conditions. The polyethylene may be breathable, and may be constructed in a tight or loose weave, depending on the needs of the user.

FIG. 2a illustrates a side view of the frame 206 that may support the cover of a shield 101 (as shown in FIG. 1), according to an aspect. The frame 206 may have a stem 203, support sticks 204 (“sticks” or “support sticks”), and pads 105 through which the support sticks 204 can be inserted by the user. The height of the stem 203 may be adjustable, such as, for example, by being available in a variety of sizes, or as another example, may be adjusted by the user by being telescopic. A lower end 203-b of the stem 203 may be blunt as shown, or may be pointed to facilitate inserting the stem 203 into the soil. A pad 205 for receiving the support sticks 204 may be placed on an upper end 203-a of the stem 203, and is preferably made from rubber, and may secure the support sticks 204 through friction-based insertion. The support sticks 204 may have a distal end 204-a and a proximal end 204-b, and may be inserted into the pad 205 by the proximal end 204-b. The support sticks 204 may be rigid for holding and supporting a cover, and may be constructed from fiberglass. An advantage is that the fiberglass material may be resistant to rusting or cracking.

FIG. 2b illustrates side views of pads 205 that may be placed at an upper end 203-a of the frame 206 stem 203, according to an aspect. The pads 205 may have a plurality of holes 207 through which the support sticks 204 may be placed by the user, as shown in FIG. 2a. The user may insert as many support sticks 204 as are determined to be needed into the pads 205, to create a circular arrangement for a cover to be supported on. The holes 207 may be distributed all around the pad 205, along 360 degrees around the pad 205, and may be oriented at various angles in relation to the horizontal plane, such that the user may customize the angle of the support sticks 204, by inserting the proximal end 204-b of the support sticks 204 at a desired angle with relation to a horizontal plane into the pad 205. As an example, the support sticks 204 may be inserted into the pad 205 at a 45 degree angle in relation to the horizontal plane, such that the distal ends 204-a of the support sticks 204 are pointed towards the lower end 203-b of the stem 203. As another example, the support sticks 204 may be inserted into the pad 205 at a 90 degree angle with relation to the horizontal plane, such that the circular arrangement of support sticks 204 is parallel to the horizontal plane. The support sticks 204 may be placed and arranged by the user in any suitable way such that the cover does not interfere with the growth of the plant, and does not rest on the plant itself. The support sticks 204 may also be in varying lengths to accommodate the size of the plant. The cover may then conform to the shape and size of the plant when laid over the support sticks 204 to protect the trees or other crops.

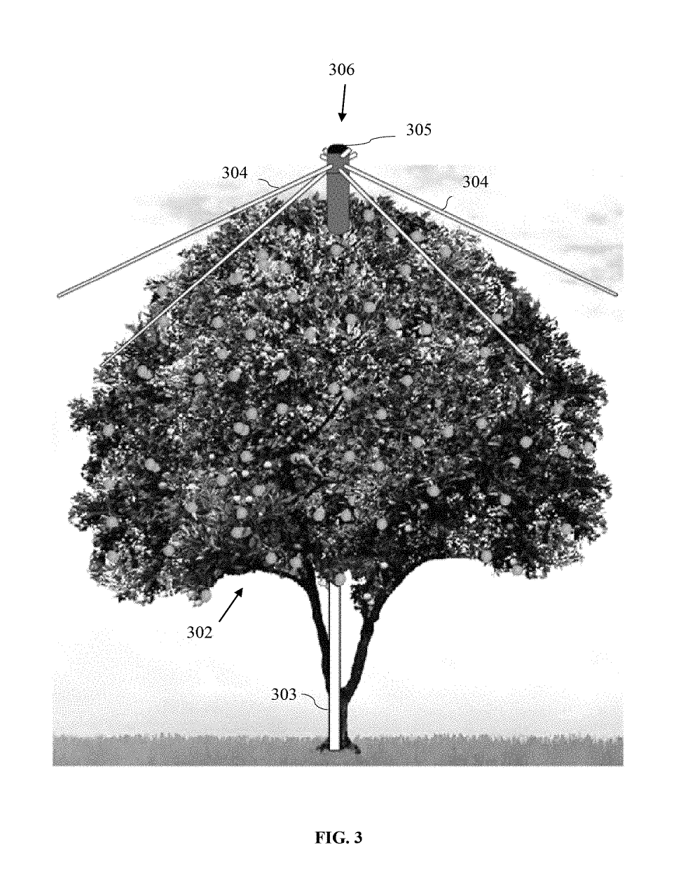

FIG. 3 shows a side view of a frame 306 that may be installed on a fruit tree 302, according to an aspect. The stem 303 may be held in place by securing it directly into the ground, and may be held upright near or against the trunk of the tree 102. The stem 303 may extend above the tree 102, such that the pad 305 and support sticks 304 that are inserted into the pad 105 fan out above the tree 102.

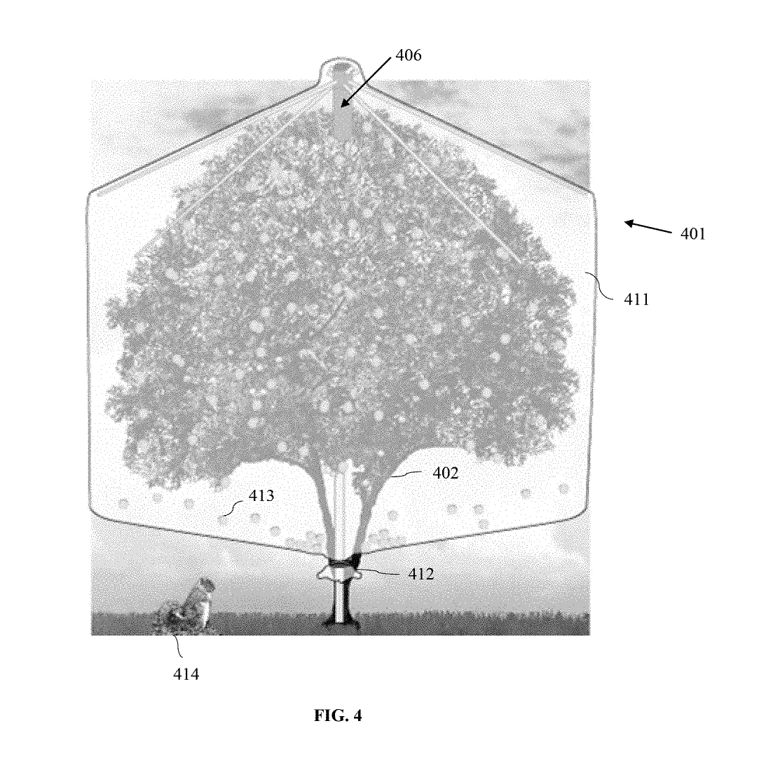

FIG. 4 shows a side view of a shield 401, having a cover 411 supported by a frame 406, protecting a tree 402, according to an aspect. The shield 401 may be tied together at a point 412 above ground level, such that fruit 413 that naturally falls off of the tree 402 may be caught by the cover 411 without touching the ground. An advantage is that the fruit 413 may be protected from the reach of pests 414 on the ground. Another advantage is that the cover may prevent the pests 414 from climbing into the tree 402 or any other plants protected by the shield 401.

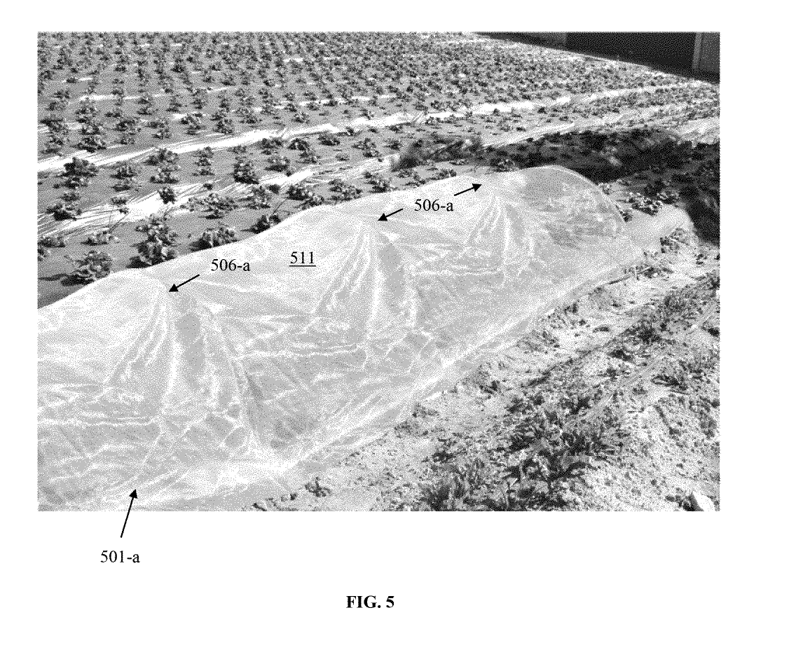

FIG. 5 shows a top perspective view of a shield 501-a having a bunker frame 506-a (“bunker shield”) and cover 511, placed over crops for protection of the crops, according to an aspect. A bunker style frame 506-a may be used to assemble a shield for protecting smaller crops such as vegetables, or shorter trees, for example. The cover 511 may be held in place by weighing it down by soil or sand bags, pinning it to the ground, or by using any other suitable means.

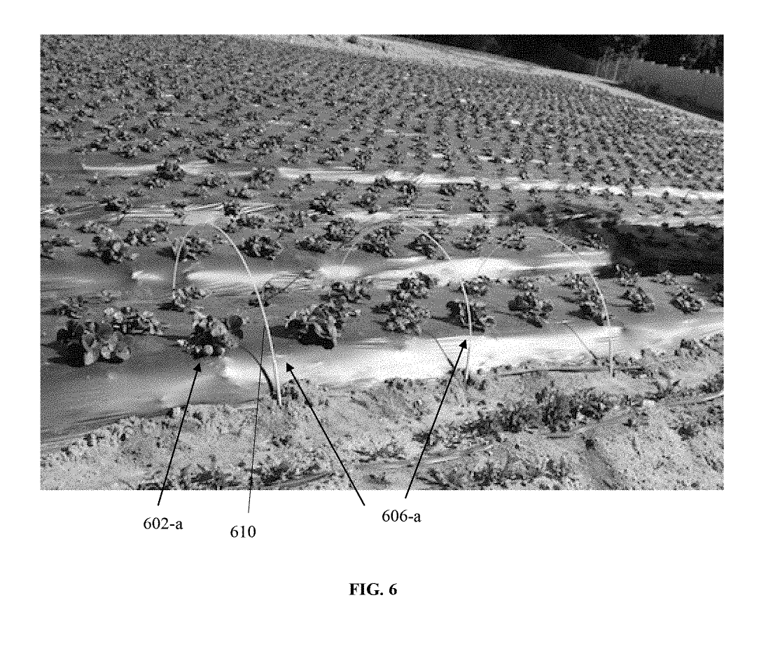

FIG. 6 shows a side perspective view of the bunker frame 606-a that may be positioned over the crops 602-a to be protected by the shield 501-a, according to an aspect. The bunker frame 606-a may be curved as shown, so as to curve over the crops 602-a, and may be held upright by driving each end into the ground on opposite sides of the crops to be protected, as shown. A row of frames 606-a may be used as shown in order to create a long bunker style shield (as shown as 501-a in FIG. 5). The bunker frame 606-a may be constructed of fiberglass, or any other suitable material. An advantage of the fiberglass frame is that it is stronger than metal or wood, and resists breakage or rusting. It should be noted that the length of each bunker stick 610 of the bunker frame 606-a may be selected to accomplish the height and/or width of the plants or rows of plants being protected.

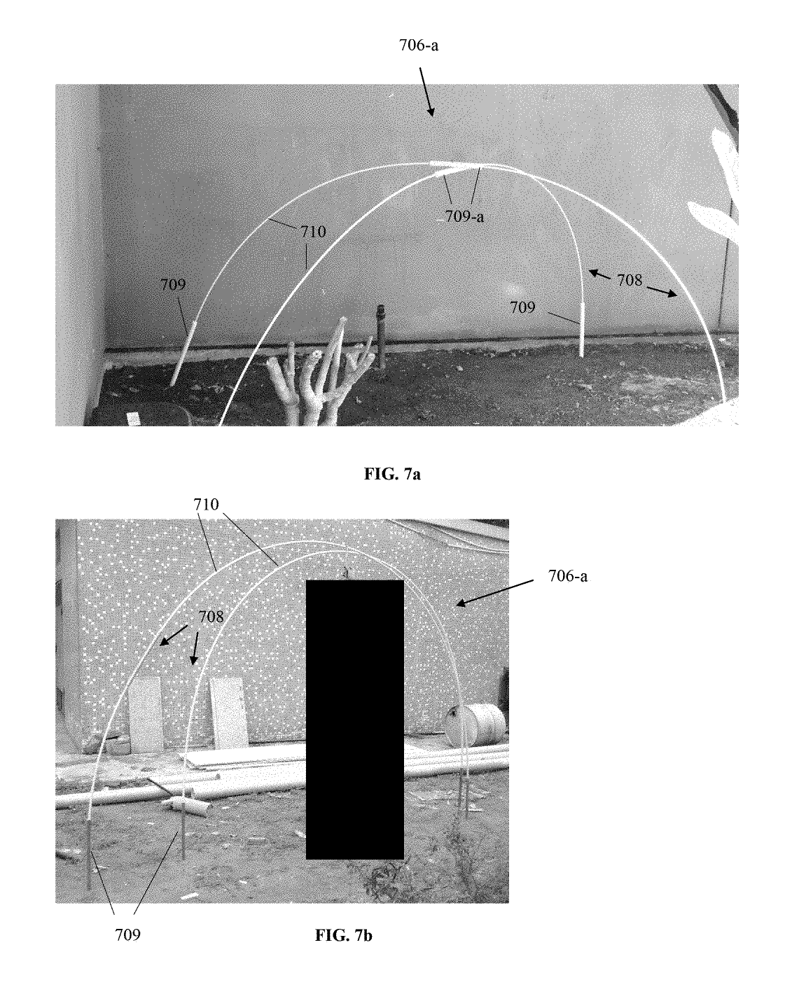

FIGS. 7a-7b show examples of side perspective views of a bunker frame 706-a having two legs 708, according to an aspect. Each leg 708 may be constructed by using posts 709 and connection members 709-a and bunker sticks 710 (“bunker sticks,” “flexible sticks,” or “bunker frame sticks”), such that the user may customize the length of any leg 708 by combining a desired number of bunker sticks 710, posts 709 and connection members 709-a. A post 709 may be used for inserting into the soil, and may also have a hollow shaft for receiving a bunker stick 710. A post 709 or a connection member 709-a having a hollow shaft may be used to adjust the length of the leg 708. As an example, two bunker sticks 710 may be inserted into the hollow shaft of the connection member 709-a, one at each end of the connection member 709-a. The user may make as many connections as needed to customize the length of each leg 708.

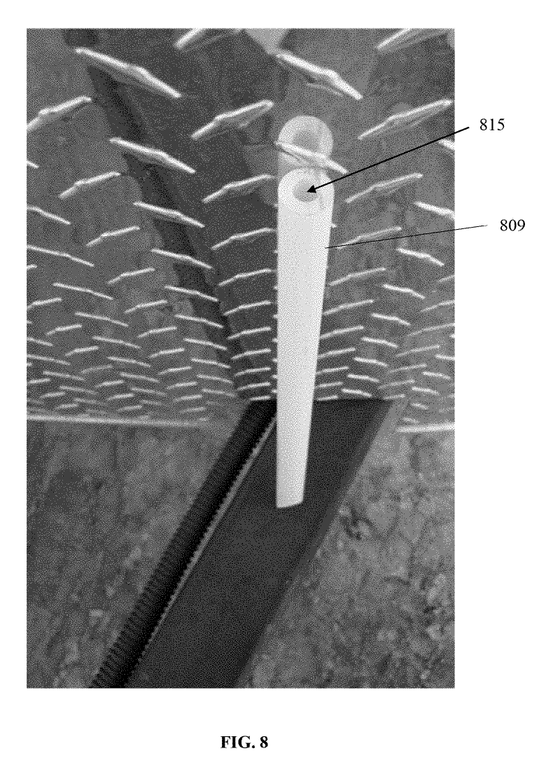

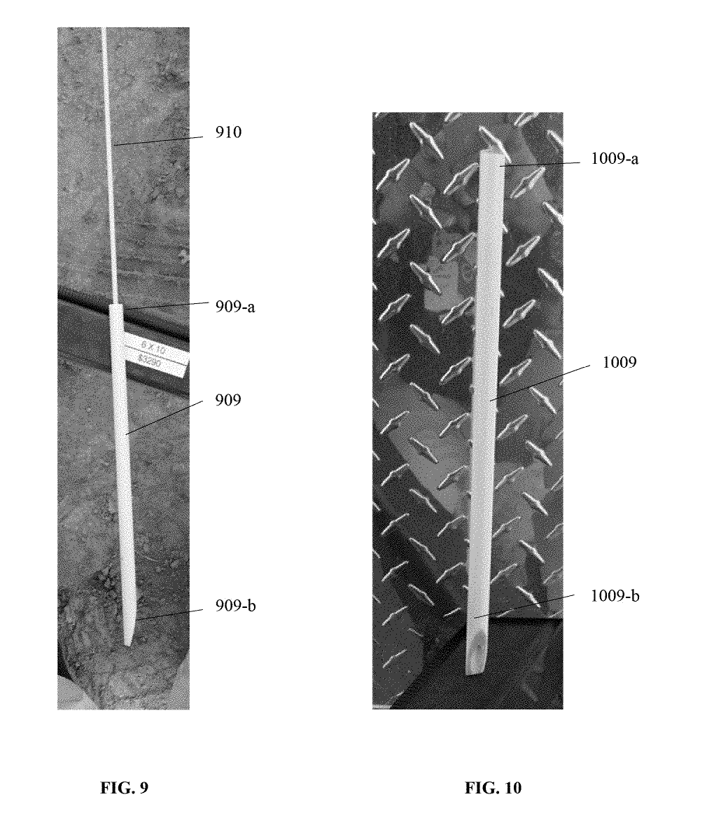

As an example, two legs 708 may be crossed over one another to create a bunker frame 706-a that may support a cover. The posts 709 may be hollow (as shown in FIGS. 8-9) such that the bunker frame sticks 710 may be inserted into them. The bunker frame sticks 710 may be flexible, such that they may curve over the plants to be covered by the shield 501-a. Another advantage may be that the size and shape of the bunker frame 706-a may be adjustable due to the flexibility of the bunker sticks 710. The bunker sticks 710 may be of any suitable length so that the desired height of a bunker shield 501-a may be created. As shown in FIG. 7a, a leg 708 having a first end and a second end may be assembled by, for example, a post on the first end and a post on the second end, and a post in the middle, with sticks inserted in between the posts. An advantage is that the user may assemble or disassemble the shield 501-a without assistance, and may easily store the components after disassembly. Another advantage is that it is easy for the user to adjust the height of the frame.

As shown in FIG. 7b, a leg may also be assembled by using two posts 709, and a bunker stick 710 inserted between the posts 709, without a connection member (as shown as 709-a in FIG. 7a). A leg 708 may have a first end and second end, each end having a post 709 being inserted into the soil. The legs 708 may be constructed in various sizes, thicknesses, and lengths, such that the user may customize the shape of their shield.

A bunker frame 706-a may be created by using multiple legs 708, such as, for example, two legs 708 crossed over one another as shown in FIGS. 7a-7b. The bunker frame sticks 710 may be removed from the posts 709 to disassemble the shield 501-a, while the posts 709 may remain in the soil. An advantage may be that future reassembly of the shield 501-a may be faster and more convenient for the user.

FIG. 8 shows a top perspective view of a post 809 that may support the bunker frame of FIG. 5, showing that the post 809 may be hollow, as shown by 815, according to an aspect. The bunker sticks may be placed inside of the hollow shaft 815 of the post 809. The post 809 may be stiff, such that they remain upright when placed in the soil. Again, the bunker frame sticks 810 may be flexible such that they may be curved to fit over the crops.

FIG. 9 shows a side view of a post with a bunker stick 710 inserted into the hollow shaft of the post 709 of FIG. 8. The bunker stick 710 may be inserted into the upper end 709-a of the post, such that the lower end, which may be pointed, may be driven into the soil. The bunker stick may be thinner than the post for easy insertion into the post.

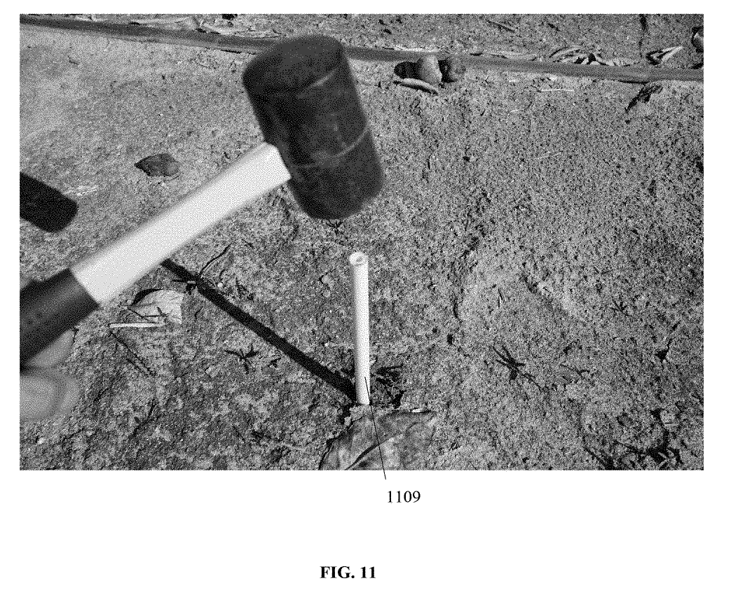

FIG. 10 shows a front view of the post of FIG. 9, showing that the lower end 1009-b of the post 1009 may be pointed for facilitating driving the post 1009 into the soil, according to an aspect. The upper end 1009-a of the post 1009 may be flat or blunt, as shown.

FIG. 11 shows a top side perspective view of the post 1109 of FIG. 8, placed upright into the soil, according to an aspect. The post may be secured by, for example, hammering it with the lower end (as shown by 1009-b in FIG. 10) into the soil. Once all posts 1109 of the shield 501-a are placed into the soil alongside the crops to be protected, the bunker frame sticks 710 and a cover 511 may be assembled to create the frame 706-a by the user. The bunker frame sticks 710 and the cover 511 may be removed if the protection is no longer needed or if crops are to be harvested. The posts may remain in the soil. An advantage may be that the user may easily re-assemble a new shield by using the posts already present in the soil for protecting crops whenever protection is determined to be needed.

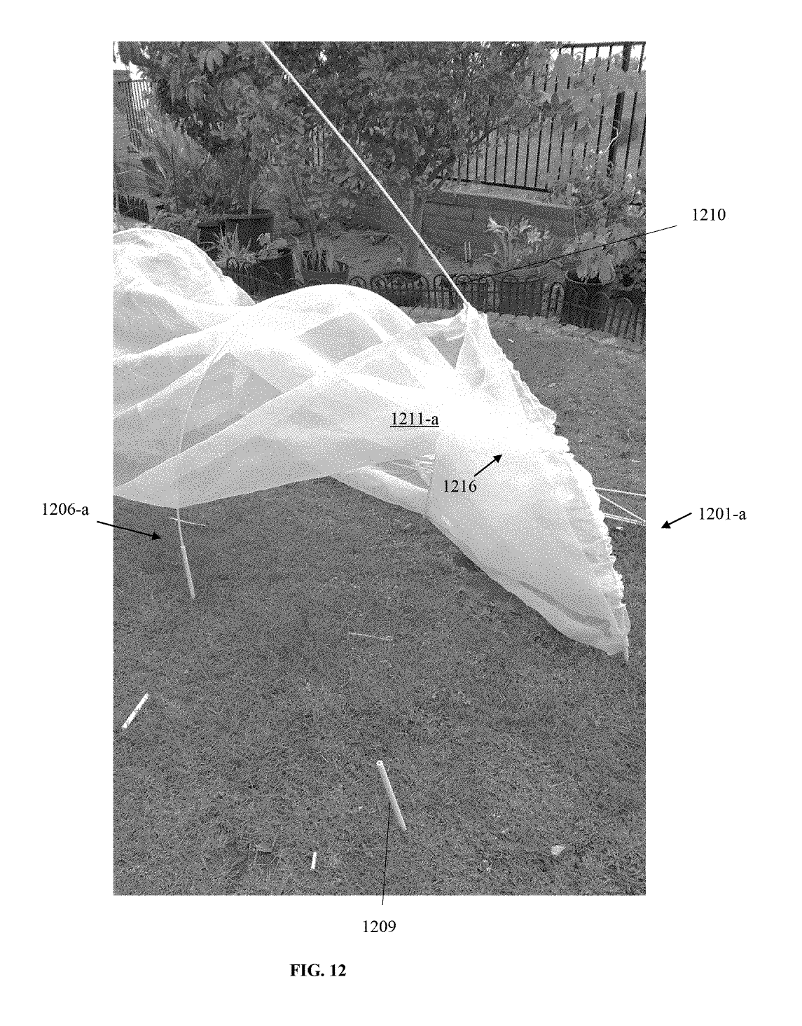

FIG. 12 shows a side perspective view of a bunker shield 1201-a with a cover 1211-a having a looped edge 1216, according to an aspect. The bunker frame sticks 1210 may be inserted into the looped edge 1216, such that the cover 1211-a is secured to the bunker frame 1206-a. Once the cover 1211-a is secured to the bunker frame 1206-a, the bunker frame stick 1210 may be inserted into a post 1209. An advantage is that no additional means for securing the cover 1211-a to the bunker frame 1206-a are needed.

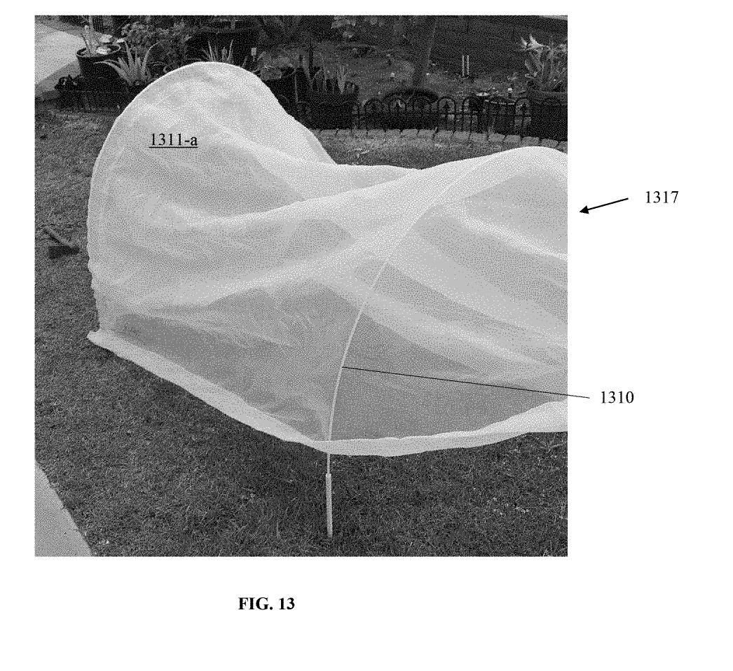

FIG. 13 shows a side perspective view of a screen house bunker shield 1317, according to an aspect. The screen house 1317 may be similar to a greenhouse, and may be more convenient or easier for the user to assemble and disassemble. The screen house 1317 may include a cover 1311-a having a looped edge. The size of the screen house 1317 may also be customizable by the user, such as, for example, by using a variety of different lengths of bunker frame sticks 1310. The screen house 1317 may be constructed in a variety of sizes as needed by the user. As an example, the screen house 1317 may be 15 feet wide, 12 feet high, and 300 feet long. The screen house 1317 may also be smaller or larger depending on the needs of the user. The bunker frame sticks 1310 may be connected to create larger screen houses 1317, for example.

If ventilation or less coverage is needed, the user may slide the cover 1311-a along the bunker frame 1317 in order to lift the cover up. For example, more ventilation may be desired in the summer, and a user may provide more air for the plants without disassembly of the entire shield. An advantage may be that the use of the shield 1317 is convenient and the removal of the entire frame and cover 1311-a is not necessary.

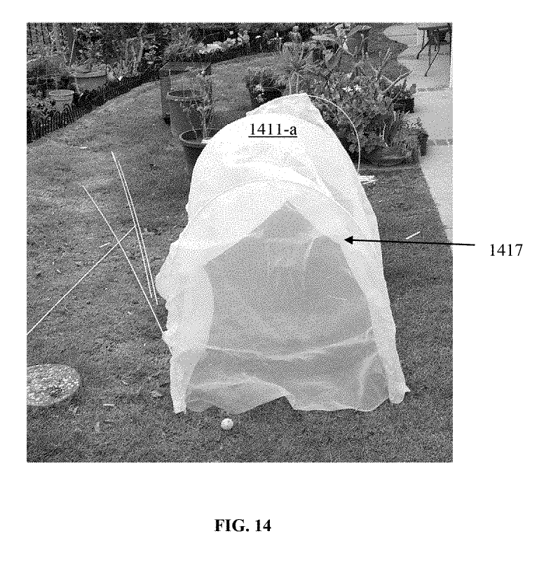

FIG. 14 shows a front top perspective view of a screen house bunker shield 1417, according to an aspect. The cover 1411-a may include a looped edge for receiving the bunker frame sticks 1210 and may cover all sides of the frame, and the front as shown, and back.

For larger needs, a cover may be provided which includes a means for attachment, such as, for example, Velcro, a zipper, and so on. The cover may thus be extended and the size may be customized by the user by attached several covers together.

It should be understood that the systems described herein may be used for other applications. Similar to the screen house 1317, the bunker frame sticks 1310 and cover 1311 or cover with a looped edge 1311-a may be used to create other structures, such as, for example, tents for camping or for the beach, protection for outdoor food, baby play pens, and so on. The cover may also be extended by joining pieces together to protect, for example, a swimming pool or spa, and so on, to prevent leaves or other debris from falling into the water, and prevent insects from getting into the water. The cover, when used to protect a swimming pool or spa, may be breathable such that the sunlight may still shine through the cover. The cover may durable and maintain its color through such outdoor use. As another example, the cover may be used to protect a user's body when using a sleeping bag that does not cover the whole body. The user may use any sleeping bag or similar item, and then may cover and protect their entire body by wrapping a cover around their body and the sleeping bag and enclosing both their body and the sleeping bag entirely. The head of the user may then be protected by the cover from, for example, insects or other pests. As another example, the full-body protection of the cover may be used by users in war zones where a sleeping bag, again, may not cover the entire body.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A shield for protecting a plant comprising; a stem having an upper end and a lower end; a first plurality of sticks having a proximal end and a distal end; and a pad associated with the upper end of the stem, the pad having a second plurality of holes distributed all around the pad and oriented at various angles in relation to a horizontal plane, the holes being configured for removably receiving the proximal ends of the entire first plurality of sticks or a portion thereof and securing the same therein through friction-based insertion; the second plurality of holes distribution and orientation allowing the formation of a support structure for a protective cover in which the entire first plurality of sticks or a portion thereof extends in a circular arrangement above the plant at an angle conforming to the shape or size of the plant.

2. The shield of claim 1, wherein the stem and the first plurality of sticks are constructed from fiberglass.

3. The shield of claim 1, further comprising the protective cover for support by the first plurality of sticks while covering the plant.

4. The shield of claim 1, wherein the lower end of the stem is configured for insertion into a soil near the plant, and the upper end of the stem is configured to extend above the plant.

5. The shield of claim 1, wherein the sticks have varying lengths to accommodate the size of the plant.

6. The shield of claim 3, wherein the shield is configured to protect a tree having foliage, and for the cover to be secured around the tree below the foliage and above a soil in which the plant is planted.

7. The shield of claim 3, wherein the cover is breathable.

8. The shield of claim 3, wherein the cover is constructed from polyethylene.

9. The shield of claim 3, wherein the cover has an edge and further comprises an attachment means along the edge such that the cover can be joined at the edge using the attachment means with other covers having corresponding attachment means at their edges in order to create a larger resulting cover.

10. A shield for protecting a plant comprising a frame and a cover; the frame having a plurality of posts; and a plurality of flexible sticks, each post of the plurality of posts having a hollow shaft and having an upper end and a lower end, the lower end having a point to be driven into soil, and the upper end being capable of removably receiving by insertion into the hollow shaft at least one of the plurality of flexible sticks, such that at least one of the plurality of posts can be driven into the soil on either side of the plant to be protected, and the plurality of flexible sticks after insertion curve over the plant, and the cover can now be placed on the plurality of flexible sticks such that the plant is covered by the cover.

11. The shield of claim 10, wherein the plurality of posts and the plurality of flexible sticks are constructed from fiberglass.

12. The shield of claim 10, wherein the cover is constructed from polyethylene.

13. The shield of claim 10, wherein the cover is breathable.

14. The shield of claim 10, wherein the cover has an edge and further comprises an attachment means along the edge such that the cover can be joined at the edge using the attachment means with other covers having corresponding attachment means at their edges in order to create a larger resulting cover.

15. The shield of claim 10, wherein the cover has a looped edge, configured for receiving at least one of the plurality of flexible sticks and thus securing the cover to the frame.

16. The shield of claim 10, further comprising a plurality of connection members; each member of the plurality of connection members having a hollow shaft, a first end, and a second end; and being capable of extending the length of the plurality of flexible sticks, by receiving by insertion into the hollow shaft through the first end a first flexible stick of the plurality of flexible sticks; and receiving by insertion into the hollow shaft through the second end a second stick of the plurality of flexible sticks; such that a user can create a variety of sizes of the frame.

17. A method of protecting a plant, using the shield of claim 10, comprising the steps of:
i. inserting the plurality of hollow posts into a soil around the plant;
ii. creating a frame by inserting at least one flexible stick into each one of the plurality of hollow posts;
iii. curving the at least one flexible stick over the plant;
iv. placing the cover on top of the at least one flexible stick to create a covering over the plant;
v. securing the cover on the soil;
vi. removing the cover and the at least one flexible stick when a user determines the covering is not needed while the plurality of posts remains in the soil; and
vii. replacing the covert and the at least one flexible stick when the user determines the covering is needed.

18. The method of claim 17 further comprising placing at least one flexible stick into a looped edge of the cover for securing the cover to the frame.
